(19) United States
(12) Patent Application Publication
(10) Pub. No.: US 2026/0154106 A1
(43) Pub. Date: Jun. 4, 2026

(54) DATA DISPATCH METHOD, SYSTEM, AND DEVICE

(71) Applicant: Lenovo (Beijing) Limited, Beijing (CN)

(72) Inventors: Haotian YUAN, Beijing (CN); Ziyao YU, Beijing (CN); Qihua XIAO, Beijing (CN)

(21) Appl. No.: 19/394,185

(22) Filed: Nov. 19, 2025

(30) Foreign Application Priority Data
Nov. 29, 2024 (CN) 202411749604.6

(51) Int. Cl. G06F 9/48

(52) U.S. Cl. CPC G06F 9/4881

(57) ABSTRACT

A data dispatch method includes: obtaining a user request; calling a corresponding target model object based on the user request; and dispatching data of functional submodules of the target model object to corresponding target hardware units based on a preset correspondence between functional submodules of a model object and execution priorities of hardware units, thereby utilizing available resources of the target hardware unit to process the user request, where each functional submodule of the target model object is configured to perform inference operations on data corresponding to the user request, and the preset correspondence is determined based on execution speed of each functional submodule on different hardware units.

### CROSS-REFERENCE TO RELATED APPLICATION(S)

This application claims priority to Chinese Patent Application No. 202411749604.6 filed on Nov. 29, 2024, which is incorporated herein by reference in its entirety.

### FIELD OF THE TECHNOLOGY

The present disclosure relates to a field of large model technology, and in particular to a data dispatch method, system, and device.

### BACKGROUND

As artificial intelligence (AI) large models gain increasing influence in the industry, more local large models are being presented to electronic device providers. However, large models have numerous parameters and complex structures, requiring significant hardware resources to run. When using large models to process tasks, how to effectively utilize these hardware resources, improve their operational efficiency, and increase task response speed are pressing challenges in the technical field.

### SUMMARY

In one aspect, the present disclosure provides a data dispatch method. The method includes: obtaining a user request; calling a corresponding target model object based on the user request; and dispatching data of functional submodules of the target model object to corresponding target hardware units based on a preset correspondence between functional submodules of a model object and execution priorities of hardware units, thereby utilizing available resources of the target hardware unit to process the user request, where each functional submodule of the target model object is configured to perform inference operations on data corresponding to the user request, and the preset correspondence is determined based on execution speed of each functional submodule on different hardware units.

In another aspect, the present disclosure provides an electronic device. The device includes: a memory storing computer program instructions; and a processor coupled to the memory and configured to execute the computer program instructions and perform: obtaining a user request; calling a corresponding target model object based on the user request; and dispatching data of functional submodules of the target model object to corresponding target hardware units based on a preset correspondence between functional submodules of a model object and execution priorities of hardware units, thereby utilizing available resources of the target hardware unit to process the user request, where each functional submodule of the target model object is configured to perform inference operations on data corresponding to the user request, and the preset correspondence is determined based on execution speed of each functional submodule on different hardware units.

In yet another aspect, the present disclosure provides a non-transitory computer-readable storage medium storing computer program instructions executable by at least one processor to perform: obtaining a user request; calling a corresponding target model object based on the user request; and dispatching data of functional submodules of the target model object to corresponding target hardware units based on a preset correspondence between functional submodules of a model object and execution priorities of hardware units, thereby utilizing available resources of the target hardware unit to process the user request, where each functional submodule of the target model object is configured to perform inference operations on data corresponding to the user request, and the preset correspondence is determined based on execution speed of each functional submodule on different hardware units.

### BRIEF DESCRIPTION OF THE DRAWINGS

FIG. 1 is a flow chart illustrating a data dispatch method according to certain embodiments of the present disclosure;

FIG. 2 is a schematic diagram illustrating an architecture of a local multimodal and multimodel service system according to certain embodiments of the present disclosure;

FIG. 3 is a schematic diagram illustrating a structure of a data dispatch system according to certain embodiments of the present disclosure; and

FIG. 4 is a schematic diagram illustrating a structure of a data dispatch device according to certain embodiments of the present disclosure.

### DETAILED DESCRIPTION

The following provides a description of the technical solutions in certain embodiments of the present disclosure, with reference to the accompanying drawings.

To further clarify the objectives, technical solutions, and advantages of the present disclosure, the following describes the present disclosure with reference to the accompanying drawings. The embodiments described should not be construed as limiting the present disclosure. Embodiments devised by persons of ordinary skill in the technical field without inventive effort are to fall within the scope of protection of the present disclosure.

In the description, references to “certain embodiments” describe subsets of all possible embodiments. However, “certain embodiments” may be the same subset or different subsets of all possible embodiments, and may be combined without conflict.

In the description, the terms “first” and “second” are used to distinguish similar objects and do not necessarily represent an ordering of the objects. The order or sequence of “first” and “second” may be interchanged where permitted, so that the embodiments described herein may be implemented in an order other than that illustrated or described herein.

Unless otherwise defined, technical and scientific terms used herein have the same meanings as commonly understood by those skilled in the technical field to which the present disclosure belongs. The terms used herein are for the purpose of describing certain embodiments of the present disclosure and are not intended to limit the present disclosure.

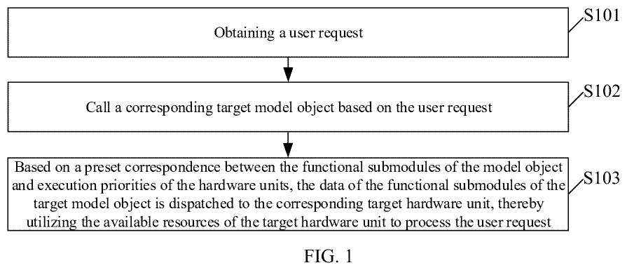

Certain embodiments of the present disclosure provide a data dispatch method. This method may be applied to a first device, which may be a desktop computer, a laptop computer, a local server, a cloud server, or the like. As shown in FIG. 1, a flow chart of a data dispatch method provided in certain embodiments of the present disclosure is provided. The method includes:

S101. Obtain a user request.

In certain embodiments, the user request may be triggered by a user clicking or touching a control or content in a corresponding human-computer interaction interface of a first device. The human-computer interaction interface may be an interface of application software running on the first device, such as a chat interface of a chat application or a search interface of a map navigation application.

In certain embodiments, multiple user requests may be received within a preset time period. These requests may originate from the same application, such as a chat application. They may also originate from different applications, such as a chat application and a map navigation application.

S102. Call a corresponding target model object based on the user request.

The target model object may be a large model or other artificial intelligence model. For example, the target model object may include a large language model, such as the Bidirectional Encoder Representations from Transformers (BERT) model, the Generative Pre-Trained Transformer (GPT) model, or the like. The following description takes the target model object as a large model.

In certain embodiments, after receiving a user request, the user request may be analyzed to determine the processing task corresponding to the user request and the task type corresponding to the processing task. A target model object capable of processing tasks corresponding to the task type may then be determined and called.

For example, when the task type corresponding to the user request is determined to be an image generation task, the target model object may be determined to be a large model of the image generation type; when the task type corresponding to the user request is determined to be a text generation task, the target model object may be determined to be a large model of the text generation type.

In certain embodiments, the determined target model object may include multiple ones. In this case, any one of the multiple target models may be called; alternatively, based on the number of parameters in the model, the target model object with the fewest parameters may be called.

S103. Based on a preset correspondence between the functional submodules of the model object and execution priorities of the hardware units, the data of the functional submodules of the target model object is dispatched to the corresponding target hardware unit, thereby utilizing the available resources of the target hardware unit to process the user request.

In certain embodiments, the functional submodules of the target model object are used to perform inference operations on the data requested by the corresponding user. These functional submodules may be fully functional submodules of the model object. For example, when the model object is a large language model, its corresponding functional submodules may include a natural language encoding submodule and a text prediction submodule.

In certain embodiments, the functional submodules of a model object may be divided based on the functionality implemented or the number of network layers in the model. For example, when the model object is a deep neural network with 100 network layers, the model object may be divided into five functional submodules, with the model parameter weight files corresponding to each of the 20 layers being one functional submodule.

In certain embodiments, the hardware unit may be a hardware processing unit of the first device, such as a central processing unit (CPU), a graphics processing unit (GPU), a neural processing unit (NPU), or the like.

In certain embodiments, the preset correspondence between various functional submodules of the model object and execution priorities of the hardware units may be pre-established, and the preset correspondence may be determined based on the execution speeds of the various functional submodules on different hardware units. Through this preset correspondence, the order of the execution speeds of the different functional submodules on the different hardware units of the first device may be determined. For example, when the hardware units include a CPU, a GPU, and an NPU, in this preset correspondence, the execution priorities of the hardware units of the natural language encoding submodule of the large language model may be, from high to low, CPU, NPU, GPU, for example, the execution speed of the natural language encoding submodule on the CPU is the fastest, the execution speed on the NPU is the second fastest, and the execution speed on the GPU is the slowest.

In certain embodiments, the target model object includes multiple functional submodules, and the execution priorities of the hardware units corresponding to different functional submodules may be different. The hardware units with the highest execution priority corresponding to different functional submodules may be determined based on the preset correspondence, and then the data of each functional submodule may be dispatched to the hardware unit with the highest execution priority. The data of the functional submodule may include the weight file of the model parameters corresponding to the functional submodule.

In certain embodiments of the present disclosure, a user request is obtained; based on the user request, a corresponding target model object is called; based on the preset correspondence between the various functional submodules of the model object and the execution priorities of the hardware units, the data of the functional submodules of the target model object are dispatched to the corresponding target hardware unit to utilize the available resources of the target hardware unit to process the user request. In this way, through the preset correspondence between the various functional submodules of the model object and the execution priorities of the hardware units, the target hardware unit that may make the functional submodules of the target model object execute at the fastest speed may be determined from the multiple hardware units of the first device, and the data of the functional submodules may be further dispatched to the corresponding target hardware computing power unit to process user requests, which may improve the operating efficiency of the target model object and increase the response speed to user requests.

In certain embodiments of the present disclosure, in the process of creating a preset correspondence between the various functional submodules of the model object and the execution priorities of the hardware units, the first task type corresponding to the reference functional submodule may be determined; the data of the reference functional submodule may be dispatched to different hardware units to obtain the reference execution speeds of the different hardware units for the user requests for the first task type; and a preset correspondence may be established based on each reference execution speed.

In certain embodiments, the reference functional submodule is any one of the functional submodules. The reference functional submodule may be any one of the functional submodules corresponding to multiple model objects, all of which may be large models.

In certain embodiments, the first task type may be the type of task that the reference functional submodule may handle. For example, when the reference functional submodule may handle image generation tasks, its corresponding first task type may be an image generation task; when the reference functional submodule may handle text generation tasks, its corresponding first task type may be a text generation task.

In certain embodiments, the data of the reference functional submodule may include a model parameter weight file for the reference functional submodule. The model parameter weight file for the reference functional submodule may be dispatched to each hardware unit of the first device to detect reference execution speeds of the different hardware units in processing user requests of the first task type.

In certain embodiments, where the hardware units of the first device include a CPU, an NPU, and a GPU, user request data of the same first task type and data of the reference functional submodule may be dispatched sequentially to the CPU, NPU, and GPU to obtain reference execution speeds of the CPU, NPU, and GPU, respectively, when processing user requests of the first task type based on the data of the reference functional submodule.

In certain embodiments, the reference execution speeds may be ranked based on their magnitude, thereby obtaining the preset correspondence between the execution priorities of the hardware units and the reference functional submodules. Hardware units with faster reference execution speeds have higher execution priorities.

In certain embodiments, S201 through S203 may be performed sequentially for each functional submodule of multiple model objects to obtain a preset correspondence between different functional submodules and the execution priorities of hardware units. These preset correspondences may then be integrated to obtain a preset correspondence between the functional submodules of multiple model objects and the execution priorities of hardware units.

In certain embodiments, a second task type corresponding to a complete model object may also be determined; the data of the model object may be dispatched to different hardware units to obtain the execution speeds of different hardware units in processing user requests of the second task type based on the model object, and a preset correspondence between the model object and the execution priority of each hardware unit may be established based on each execution speed. That is, the established preset correspondence may include the preset correspondence between the model object and the execution priority of each hardware unit, and may also include the preset correspondence between the functional submodules of the model object and the execution priority of each hardware unit.

In certain embodiments, the preset correspondence between the functional submodules and the execution priorities of each hardware unit may be represented in the form of a preset correspondence table. For example, as shown in Table 1, the hardware units of the first device include a CPU, an integrated graphics card (iGPU), a dedicated graphics processing unit (dGPU), and an NPU. The text translation module Translator, the text decoding module Text encoder, the variational auto-encoder decoder (Variational Auto-Encoder, VAE decoder), the super-resolution reconstruction module Super Resolution, and the image segmentation module Segmentation are all functional submodules of the model object, and the U-shaped network (UNET) and the large language model (LLM) are model objects. Among them, 1, 2, 3, and 4 represent the execution priorities of each hardware unit in processing the tasks of the corresponding functional submodules or model objects. The larger the number, the lower the execution priority. For example, for the model object LLM, the corresponding CPU execution priority is 4, the iGPU execution priority is 2, the dGPU execution priority is 1, and the NPU execution priority is 3. That is, the priority of each hardware unit in processing the tasks corresponding to the model object LLM is dGPU, iGPU, NPU and CPU in descending order.

TABLE 1
Preset correspondence between model objects/functional submodules and
hardware unit execution priorities

| Hardware unit | | | | |
|---|---|---|---|---|
| Execution priorities | | | | |
| Model objects/functional | | | | |
| submodules | CPU | iGPU | dGPU | NPU |
| Translator | 1 | 4 | 4 | 4 |
| Text encoder | 4 | 2 | 2 | 1 |
| UNET | 4 | 3 | 2 | 1 |
| VAE decoder | 4 | 2 | 2 | 1 |
| LLM | 4 | 2 | 1 | 3 |
| Super Resolution | 3 | 1 | 2 | 1 |
| Segmentation | 3 | 1 | 2 | 1 |

In certain embodiments, after creating a preset correspondence between the various functional submodules of the model object and the execution priorities of the hardware unit, the preset correspondence may be subsequently updated. For example, when a new model object is added, or a new functional submodule of the model object is added, the data of the new model object or the new functional submodule and the data of the user request of the corresponding task type may be dispatched to different hardware units for testing to obtain the execution speed of different hardware units, thereby obtaining the newly added preset correspondence; or, after the hardware unit or the parameters of the hardware unit of the first device are updated, the updated hardware unit may be re-tested for the execution speed of the data of the user request of the functional submodule or the model object corresponding to the task type, thereby obtaining the updated preset correspondence.

In certain embodiments, S201 to S203 may be performed during the process of testing the hardware unit of the first device before the first device leaves the factory, or may be performed when the first device is used for the first time after leaving the factory, or may be performed during the normal use of the first device. The present disclosure does not limit the timing of creating the preset correspondence table.

In certain embodiments, by determining the task type corresponding to the reference functional submodule, dispatching the data of the reference functional submodule to different hardware units, determining the execution speed of different hardware units for user requests of this task type, and establishing a preset correspondence between the reference functional submodule and the execution priority of each hardware unit based on each execution speed, it is convenient to directly determine the target hardware unit corresponding to the user request based on the preset correspondence when obtaining a user request of the task type corresponding to the reference functional submodule in the future, thereby improving the response speed to the user request.

In certain embodiments of the present disclosure, in the process of dispatching the data of the functional submodules of the target model object to the corresponding target hardware units according to the preset correspondence between the various functional submodules of the model object and the execution priorities of the hardware units, the current available resources of each hardware unit may be obtained; based on the available resources and the preset correspondence, the target hardware units corresponding to particular functional submodules are determined; and the data of the particular functional submodules and the data requested by the user are dispatched to the corresponding target hardware units.

In certain embodiments, the currently available resources of a hardware unit may include the number of cores, threads, and cache space currently available. In an implementation, the operating data of each hardware unit of the first device may be monitored in real time or periodically to obtain the corresponding available resources. Alternatively, upon receiving a user request, the current operating status data of each hardware unit may be tested to determine the currently available resources of the hardware.

In certain embodiments, a particular functional submodule is one or more functional submodules used to perform inference computations on the data requested by the user.

In certain embodiments, in addition to determining the computing power unit that may make each functional submodule execute at the fastest speed based on the preset correspondence between each functional submodule of the model object and the execution priority of the hardware unit, the current resource usage of each computing power unit may also be considered, that is, a comprehensive decision may be made based on the current available resources of the hardware computing power unit and the preset correspondence to determine the target hardware unit corresponding to the particular functional submodule.

In certain embodiments, the execution speed ranking result for a particular functional submodule among multiple hardware units of the first device may be determined based on the preset correspondence between the various functional submodules of the model object and the execution priorities of the hardware units, and then the target hardware unit corresponding to the particular functional submodule may be further determined based on the current available resources of each hardware unit.

In certain embodiments, when the multiple hardware units of the first device include CPU, GPU and NPU, according to the preset correspondence between the various functional submodules of the model object and the execution priorities of the hardware units, the execution speed ranking result for the particular functional submodule A from fast to slow are GPU, NPU, CPU, and the current available resources of the GPU account for 10% of all available resources of the GPU, the current available resources of the NPU account for 80% of all available resources of the NPU, and the current available resources of the CPU account for 50% of all available resources of the CPU, then the NPU may be determined as the target hardware unit for the particular functional submodule A, and the CPU may also be determined as the target hardware unit corresponding to the particular functional submodule A.

In certain embodiments, when there are multiple particular functional submodules and there is an execution order for the multiple particular functional submodules, the target hardware unit corresponding to each particular functional submodule may be determined based on the execution order. When the particular functional submodules are independent and there are no execution constraints, the target hardware unit corresponding to each particular functional submodule may be determined simultaneously.

In certain embodiments, the data for a particular functional submodule may include a model parameter weight file corresponding to the particular functional submodule, and the data of the user request may include the data content of the processing task corresponding to the user request, which may include text, audio, images, video, or the like.

In certain embodiments, after determining the target hardware unit corresponding to each particular functional submodule, the data of the particular functional submodule and the data of the user request may be dispatched to the corresponding target hardware unit, so that the target hardware unit calculates the processing task corresponding to the user request based on the data of the particular functional submodule, obtains a response result for the request, and feeds back the response result to the user.

In certain embodiments, based on the currently available resources of each hardware unit and the preset correspondence between each functional submodule of the model object and the execution priorities of the hardware unit, a comprehensive decision is made based on the theoretical execution speed priority of the hardware unit and the actual operating status of the hardware unit. This makes the target hardware unit corresponding to a particular functional submodule more reasonable, thereby improving the data execution speed of each particular functional submodule and facilitating faster response to user requests.

In certain embodiments of the present disclosure, after obtaining a user request (for example, S101), when it is determined that the currently available resources of the hardware units of the first device are unable to complete the processing of the user request, a second device with available hardware resources is identified; the user request data and the corresponding functional submodule data are transmitted to the second device, so that the hardware units of the second device may process the user request.

In certain embodiments, the second device may be an electronic device that establishes a communication connection with the first device. For example, the second device may be a remote server, a cloud server, or the like.

In certain embodiments, when it is determined that the currently available resources of the hardware units of the first device are insufficient to calculate the data of the user request based on the data of the functional submodule of the target model object corresponding to the user request, a determination may be made as to whether the second device that establishes a communication connection with the first device has available hardware resources. When it is determined that the second device has available hardware resources and that the hardware resources may complete the calculation of the data of the user request based on the data of the target model object, the data of the user request and the data of the corresponding functional submodule may be transmitted to the second device, and the user request may be processed using the hardware resources of the second device.

In certain embodiments, the hardware resources of the second device may include the currently available resources of the hardware unit of the second device, such as the number of available cores, threads, and memory space of the hardware unit. After obtaining the user request data and the data of the corresponding functional submodule, the second device may calculate the user request data based on the functional submodule data to obtain a response to the user request and transmit the response to the first device.

In certain embodiments, the second device may also have a pre-established table of correspondences between the functional submodules of a model object and the execution priorities of the hardware units. Based on the received user request, the second device may locally call the corresponding model object and, based on the table, dispatch the functional submodule data of the model object to its corresponding target hardware unit, thereby processing the user request.

In certain embodiments, when the currently available resources of the hardware unit of the first device are unable to complete processing of the user request, by sending the user request data and the data of the corresponding functional submodule to the second device for processing, the available hardware resources of the second device in communication with the first device may be effectively utilized, thereby enabling timely processing of the user request and improving the user experience.

In certain embodiments of the present disclosure, the user request includes task processing instruction information. After obtaining the user request (for example, S101), when it is determined that the task processing instruction information in the user request indicates that the current user request should be processed by the target second device, the data of the current user request is transmitted to the target second device, so that the hardware unit of the target second device may process the current user request.

In certain embodiments, the target second device may be a particular electronic device that may establish a communication connection with the first device and is indicated by the task processing instruction information.

In certain embodiments, when the task processing instruction information indicates that the current user request should be processed by the target second device, when the target second device is already connected to the first device, the data requested by the current user and the data of the corresponding functional submodule may be directly transmitted to the target second device for processing. When the target second device is not already connected to the first device, a communication connection may be established between the two electronic devices before the data of the current user request and the data of the corresponding functional submodule are transmitted to the target second device for processing.

In certain embodiments, when the task processing instruction information carried in the user request indicates that the current user request should be processed by the target second device, the data of the current user request may be transmitted to the target second device so that the current user request may be processed by the second device, thereby satisfying the user's personalized experience.

In certain embodiments of the present disclosure, the first device includes a model management module. After obtaining the user request (for example, S101), the first device may also determine the target model object corresponding to the user request. When it is determined that the management function of the model management module has passed verification, the model management module obtains a decryption key for the target model object stored on the local device. The decryption key is used to decrypt the encrypted data of the target model object to obtain data from each functional submodule of the target model object, and then inference calculations are performed on the data of the user request based on the data from each functional submodule of the target model object.

In certain embodiments, the task type of the corresponding task may be determined based on the user request, and the corresponding target model object may be determined based on the task type. The data of the target model object may be pre-stored in a storage area of the first device. The target model object data may be encrypted, so the encrypted target model object data must be decrypted before the target model object is called.

In some real-time applications, a model management module may be used to manage model objects. The management functions of the model management module may include encrypting encrypted model object data and calling model objects. Therefore, before calling the target model object, the management functions of the model management module may be verified. When the model management module passes verification, the decryption key for the target model object stored on the local device may be obtained through the model management module.

In certain embodiments, the model management module may verify the proper functioning of the model management module by calculating a check code using the Secure Hash Algorithm 256 (SHA256) based on the local timestamp, salt, and the model's unique secure decryption key. If the model management module may generate a salt and then generate a check code using the SHA256 algorithm based on the local timestamp, salt, and the model's unique secure decryption key, the model management module's proper functioning may be verified.

In certain embodiments, when the model management module's proper functioning is determined, the decryption key for the target model object obtained from the model management module may be used to decrypt the encrypted data of the target model object using the model management module's decryption function, thereby obtaining the data of each functional submodule of the target model object.

In certain embodiments, after obtaining the data of each functional submodule of the target model object, the data of each functional submodule of the target model object may be loaded into memory, thereby enabling the target model object to be called. After calling the target model object, the data of the functional submodules of the target model object may be used to perform inference calculations on the data of the user request.

In certain embodiments, verifying the management functions of the model management module helps guarantee that the data decryption and model calling functions of the model management module be functioning properly. This allows the model management module to successfully decrypt the encrypted data of the target model object and call the target model object, enabling the functional submodules of the target model object to perform inference calculations on the data of the user request.

In certain embodiments of the present disclosure, multiple user requests may be received. After obtaining the user requests (for example, S101), the target model objects corresponding to each user request and the functional submodules of each target model object may be determined. The execution order of the multiple user requests is determined based on the correspondence between the functional submodules of each target model object and the execution priority of the hardware unit, as well as the available resources of the hardware unit.

In certain embodiments, the user requests may be received simultaneously or within a preset time period, for example, within 100 milliseconds or 1 second. Based on the task type of each user request, a model object capable of processing the task corresponding to that task type may be determined as the target model object, thereby obtaining the target model object corresponding to each user request.

In certain embodiments, the execution order of multiple user requests may be determined by combining the preset correspondence between the functional submodules of each target model object and the execution priorities of the hardware unit, as well as the currently available resources of each hardware unit. The correspondence between the functional submodules of each target model object and the execution priorities of the hardware unit may be obtained from the preset correspondence between the functional submodules of the model object and the execution priorities of the hardware unit.

In certain embodiments, the execution order of user requests includes parallel processing and serial processing. When multiple user requests correspond to different target model objects, and the target hardware units corresponding to the multiple functional submodules are different based on the correspondence between the functional submodules of each target model object and the execution priorities of the hardware unit, and the available resources of the hardware unit, the data of each user request may be dispatched to different hardware units for parallel processing.

In certain embodiments, when multiple user requests correspond to the same target model object, or even when the target model objects are different but the functional submodules of the target model object correspond to the same target hardware unit, the user requests may be processed serially based on the order in which the user requests arrive or the complexity of the tasks corresponding to the user requests.

In certain embodiments, when multiple user requests are included, the functional submodules of the target model object corresponding to each user request are determined separately. The execution order of the multiple user requests is determined based on the corresponding relationship between each functional submodule of each target model object and the execution priority of the hardware unit, as well as the available resources of the hardware unit. This allows for parallel or serial processing of multiple tasks and helps ensure timely response to multiple user requests.

In certain embodiments of the present disclosure, after obtaining the user request, that is, S101, the text content in the user request may be converted into feature information. The feature information may include input data for different types of models. The feature information may be identified by a feature vector. For example, the text content in the user request may be converted into a prompt word token suitable for input of a text generation model, and each token may be used as a feature vector; for an image generation model, information such as image size and resolution may be added after the prompt word to form a feature vector corresponding to the image generation model. Information such as image size and resolution may be determined by the image generation model.

In certain embodiments, the first model object may be a text generation model, an image generation model, or another large model type, and the first and second model objects are different types of model objects. After converting the text content in the user request data into feature information, when the target model object to be called is determined to be the first model object, the feature information may be input into the first model object, enabling the first model object to process the user request.

In certain embodiments, when the first model object is a text generation model object, the second model object may be an image generation model object. When the first model object is an image generation model object, the second model object may be a text generation model object. When the target model object to be called is determined to be the second model object, the feature information may be input into the second model object, enabling the second model object to process the user request.

In certain embodiments, by converting the text content in the user request into input data for different types of models, different model objects may support input of the same modality, thereby avoiding the need to convert the user request input into the corresponding input of different model objects for different types of model objects, thereby improving the execution efficiency of user requests.

In certain embodiments of the present disclosure, a user request is obtained; based on the user request, a corresponding target model object is called; based on the preset correspondence between the various functional submodules of the model object and the execution priorities of the hardware units, the data of the functional submodules of the target model object are dispatched to the corresponding target hardware units, so as to utilize the available resources of the target hardware units to process the user request. In this way, through the preset correspondence between the various functional submodules of the model object and the execution priorities of the hardware units, the target hardware unit that may make the execution speed of the various functional submodules of the target model object the fastest may be determined from the multiple hardware units of the first device, and the data of the functional submodules may be further dispatched to the corresponding target hardware computing power unit to process the user request, which may improve the operating efficiency of the target model object and the response speed to the user request.

The following describes an implementation process according to certain embodiments of the present disclosure.

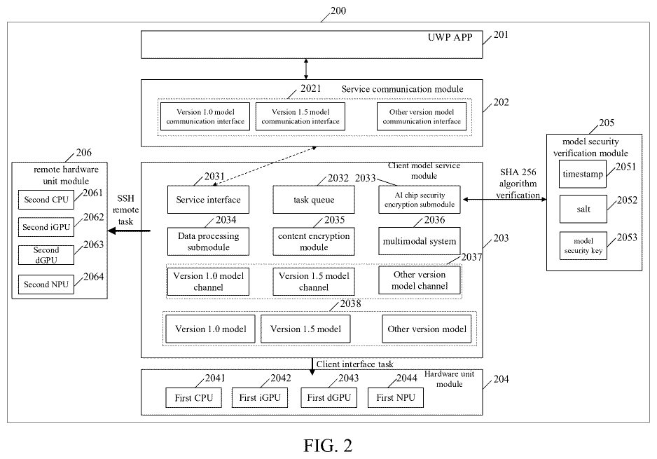

FIG. 2 shows a schematic diagram of the architecture of a local multimodal, multimodel service system provided by certain embodiments of the present disclosure. As shown in FIG. 2, the local multimodal, multimodel service system 200 includes a Universal Windows Platform (UWP) app (Application) 201, a service communication module 202, a client model service module 203 (equivalent to the “model service module” in certain embodiments), a hardware unit module 204, a model security verification module 205, and a remote hardware unit module 206.

In certain embodiments, the service communication module 202 includes a communication interface 2021 for models of different versions (for example, version 1.0, version 1.5, and other versions); the client model service module 203 includes a service interface 2031, a task queue 2032, an AI chip security encryption submodule 2033, a data processing submodule 2034, a content encryption module 2035, a multimodal system 2036, model channels of different versions 2037, a large model submodule 2038, and the like. The large model submodule 2038 includes large models of different versions (for example, version 1.0, version 1.5, and other versions). The hardware unit module 204 includes a first CPU 2041, a first iGPU 2042, a first dGPU 2043, and a first NPU 2044 of the local device (equivalent to the “hardware unit” in certain embodiments); the model security verification module 205 includes a module that may generate a local timestamp 2051, a salt 2052, and a model security key 2053; the remote device hardware unit module 206 includes a second CPU 2061, a second iGPU 2062, a second dGPU 2063, and a second NPU 2064 of the remote device.

In certain embodiments, the local multimodal multimodel service system 200 may implement multi-APP communication, and the client model service module 203 may be used as a resident background service to communicate with the APP through the client model communication component (dynamic link library) within the APP. Various APPs may integrate the same communication component to help ensure that the client model service module 203 may communicate with various APPs at the same time.

In certain embodiments, multi-task parallel large model APPs of various types may pass tasks to the client model service module 203 through local distributed communication using Remote Python Call (RPyC). The client model service module 203 may assign corresponding large models to execute tasks according to the order in which tasks arrive, and load large model tasks on different hardware units based on the operating efficiency of the models on different hardware. The mapping table of correspondences between different large models (and/or functional submodules of large models) and hardware priorities is shown in Table 1. A model task load distribution algorithm (such as a neural network distribution algorithm) may be used to assign execution hardware units to new tasks based on the mapping table and the execution status of model tasks on the hardware.

In certain embodiments, the client model service module 203 may allow the APP to register the available remote devices in the remote call module of the client model service module 203 in advance. When the local computing power has been exhausted, or the APP actively requests to use the remote computing power, the client model service module 203 may detect the remotely callable computing power through the Secure Shell Protocol (SSH) and load the inference task on the remote device hardware unit module 206 through the inference framework.

In certain embodiments, the client model service module 203 may include an obfuscated, encrypted large model module, with the model's unique security decryption key serialized within the model parameters. Anti-obfuscation decryption requires a local timestamp, salt, and the model's unique security decryption key. The client model service module 203 periodically checks to see if the model parameters have been forcibly cracked or tampered with.

In certain embodiments, the client model service module 203 and the AI chip internally use the local timestamp, salt, and model's unique security decryption key to calculate a check code using the SHA256 algorithm. These are then cross checked. When a check code passes, the model is considered secure. When a check code fails, the model is considered risky and the risky model is temporarily disabled and reported to the APP.

In certain embodiments, the client model service module 203 includes a built-in multimodal call algorithm that uses a trained text embedding model to convert a unified token into vectors used by different models for direct inference.

The local multimodal and multimodel service system provided in certain embodiments may distribute load across GPUs, NPUs, and GPUs, integrating multiple local large model algorithms to achieve multi-task parallelism. It may also implement secure encryption of large model content output and AI chip hardware encryption of model parameters. It may also implement distributed call of computing power on other remote devices for distributed computing. It may also support calling multimodal model services using unified commands or prompts.

In certain embodiments of the present disclosure, a user request is obtained; based on the user request, a corresponding target model object is called; based on the preset correspondence between the various functional submodules of the model object and the execution priorities of the hardware units, the data of the functional submodules of the target model object are dispatched to the corresponding target hardware units, so as to utilize the available resources of the target hardware units to process the user request. In this way, through the preset correspondence between the various functional submodules of the model object and the execution priorities of the hardware units, the target hardware unit that may make the execution speed of the various functional submodules of the target model object the fastest may be determined from the multiple hardware units of the first device, and the data of the functional submodules may be further dispatched to the corresponding target hardware computing power unit to process the user request, which may improve the operating efficiency of the target model object and the response speed to the user request.

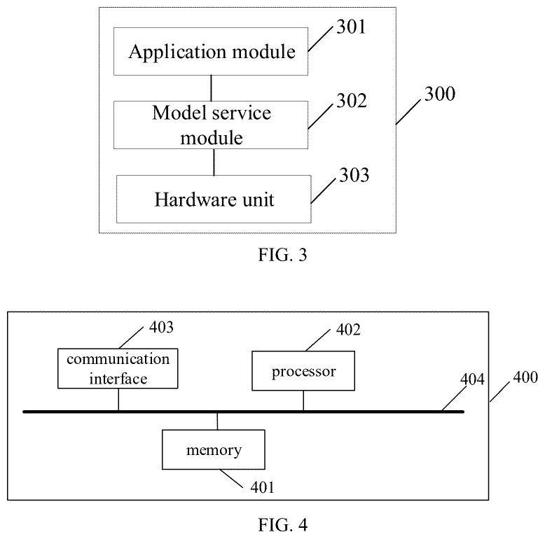

The present disclosure in certain embodiments provides a data dispatch system. FIG. 3 is a schematic diagram of the structure of a data dispatch system provided in certain embodiments of the present disclosure. As shown in FIG. 3, data dispatch system 300 includes:

Application module 301 is configured to receive user requests and, based on the user requests, call corresponding target model objects;

The model service module 302 is configured to dispatch the data of the functional submodules of the target model object to the corresponding target hardware unit based on the preset correspondence between the functional submodules of the model object and the execution priorities of the hardware units, thereby utilizing the available resources of the target hardware unit to process the user request.

The hardware unit 303 is configured to execute the data of the functional submodules of the target model object.

In certain embodiments, each functional submodule of the target model object is used to perform inference calculations on the data requested by the corresponding user, and the preset correspondence is determined based on the execution speed of each functional submodule on different hardware units.

In certain embodiments, the model service module 302 is further configured to: obtain the currently available resources of each hardware unit; determine the target hardware unit corresponding to each particular functional submodule based on the available resources and the preset correspondence; the particular functional submodule is at least one functional submodule used to perform inference calculations on the data requested by the user; and dispatch the data of the particular functional submodule and the data of the user request to the corresponding target hardware unit.

In certain embodiments, the data dispatch system 300 further includes:
a first determination module configured to determine a first task type corresponding to a reference functional submodule; the reference functional submodule being any one of the functional submodules;
a first dispatch module configured to dispatch data from the reference functional submodule to different hardware units to obtain reference execution speeds of the different hardware units for user requests related to the first task type;
A first establishment module is configured to establish the preset correspondence based on the respective reference execution speeds.

In certain embodiments, the model service module 302 is further configured to: when the currently available resources of the hardware units of the first device are unable to complete processing of the user request, determine a second device with currently available hardware resources; establish a communication connection between the second device and the first device;

transmit data of the user request and data of the corresponding functional submodule to the second device, so that the hardware units of the second device may process the user request.

In certain embodiments, the user request carries task processing instruction information; the model service module 302 is also used to: when the task processing instruction information indicates that the current user request is processed through the target second device, then the data of the current user request is sent to the target second device to use the hardware unit of the target second device to process the current user request.

In certain embodiments, the first device includes a model management module, and the model service module 302 is also used to: determine the target model object corresponding to the user request; when it is determined that the management function of the model management module has passed the verification, obtain the decryption key of the target model object stored in the local device through the model management module; use the decryption key to decrypt the encrypted data of the target model object, obtain the data of each functional submodule of the target model object, and perform inference calculations on the data of the user request based on the data of each functional submodule of the target model object.

In certain embodiments, the user request includes multiple requests; the model service module 302 is also used to: determine the target model object corresponding to each user request, and the functional submodules of each target model object; determine the execution order of multiple user requests based on the correspondence between each functional submodule of each target model object and the execution priority of the hardware unit, and the available resources of the hardware unit, and the execution order of the user requests includes parallel processing and serial processing.

In certain embodiments, the model service module 302 is also used to: convert the text content in the user request into feature information, the feature information including input data for different types of models; when the corresponding target model object is called as the first model object, the feature information is input into the first model object for processing, so that the first model object processes the user request; when the corresponding target model object is called as the second model object, the feature information is input into the second model object for processing, so that the second model object processes the user request; where, the first model object and the second model object are model objects of different types.

The description of the data dispatch system of certain embodiment of the present disclosure is similar to the description of the above-mentioned method embodiments, and has similar beneficial effects as the method embodiments, so the description will not be repeated here for brevity. For technical details not disclosed in the embodiments of the system and device, reference may be made to the description of the method embodiments of the present disclosure for understanding.

In certain embodiments of the present disclosure, when the control method of the first electronic device described above is implemented in the form of a software function module and is sold or used as an independent product, it may also be stored in a computer-readable storage medium. Based on this understanding, the technical solution of certain embodiments of the present disclosure may be embodied in the form of a software product. The computer software product is stored in a storage medium and includes several instructions for enabling a computer device (which may be a personal computer, server, or network device, or the like.) to execute all or part of the methods described in certain embodiments of the present disclosure. The aforementioned storage medium includes various media that may store program codes, such as a USB flash drive, a mobile hard disk, a read-only memory (ROM), a magnetic disk, or an optical disk. In this way, certain embodiments of the present disclosure are not limited to any specific combination of hardware and software.

Accordingly, certain embodiments of the present disclosure provide a computer-readable storage medium having a computer program stored thereon. When the computer program is executed by a processor, the control method of the first electronic device provided in certain embodiments is implemented.

The present disclosure also provides a data dispatch device. FIG. 4 is a schematic diagram of the structure of a data dispatch device provided in the present disclosure. As shown in FIG. 4, the data dispatch device 500 includes: a memory 401, a processor 402, a communication interface 403, and a communication bus 404. The memory 401 is used to store executable data dispatch instructions; the processor 402 is used to execute the executable data scheduling instructions stored in the memory to implement the data dispatch method provided in certain embodiments. The executable data scheduling instructions are used to implement: obtain a user request, and call the corresponding target model object based on the user request; dispatch the data of the functional submodules of the target model object to the corresponding target hardware unit based on the preset correspondence between the various functional submodules of the model object and the execution priorities of the hardware units, so as to utilize the available resources of the target hardware unit to process the user request; where, the various functional submodules of the target model object are used to perform inference operations on the data of the corresponding user request, and the preset correspondence is determined based on the execution speed of each functional submodule on different hardware units.

The description of the above data dispatch device and storage medium embodiments is similar to the description of the above method embodiments, and has similar beneficial effects as the method embodiments. For technical details not disclosed in the data dispatch device and storage medium embodiments of the present disclosure, reference may be made to the description of the method embodiments of the present disclosure for understanding.

In certain embodiments, the term “comprising” or any other variant thereof is intended to cover non-exclusive inclusion, such that a process, method, device, or system comprising a list of elements includes not only those elements but also other elements not explicitly listed, or elements inherent to such process, method, device, or system. In the absence of further limitations, an element described by the phrase “comprising at least one . . . ” does not preclude the presence of additional identical elements in the process, method, device, or system comprising that element.

In certain embodiments provided in the present disclosure, the disclosed devices and methods may be implemented in other ways. The device embodiments described above are schematic. For example, the division of the units is a logical function division. In implementations, there may be other division methods, such as: multiple units or components may be combined, or may be integrated into another system, or some features may be ignored or not executed. In addition, the coupling, direct coupling, or communication connection between the components shown or discussed may be through some interfaces, and the indirect coupling or communication connection of the devices or units may be electrical, mechanical or other forms.

The units described above as separate components may or may not be physically separate, and the components shown as units may or may not be physical units. They may be located in a single location or distributed across multiple network units. Some or all of these units may be selected as suitable.

Functional units in certain embodiments of the present disclosure may all be integrated into a single processing unit, each unit may be independently configured as a unit, or two or more units may be integrated into a single unit. These integrated units may be implemented in hardware or as a combination of hardware and software functional units.

Those skilled in the technical field understand that all or part of the steps in the above-described method embodiments may be implemented using hardware associated with program instructions. The aforementioned program may be stored in a computer-readable storage medium. When executed, the program performs the steps of the above-described method embodiments. The aforementioned storage medium includes various media capable of storing program code, such as a mobile storage device, ROM, magnetic disk, or optical disk.

In certain embodiments, when the aforementioned integrated unit of the present disclosure is implemented as a software functional module and sold or used as a standalone product, it may also be stored in a computer-readable storage medium. The technical solutions of certain embodiments of the present disclosure may be embodied in the form of a software product. This computer software product, stored in a storage medium, includes instructions for enabling a product to perform all or part of the methods described in the various embodiments of the present disclosure. The aforementioned storage medium includes various media capable of storing program code, such as a mobile storage device, ROM, magnetic disk, or optical disk.

The description reflects certain embodiments of the present disclosure, but the scope of protection of the present disclosure is not limited thereto. Any technical object within the technical scope disclosed in the present disclosure that may be conceived by those familiar with the technical field should be covered by the scope of protection of the present disclosure. Therefore, the scope of protection of the present disclosure should be based on the scope of protection of the claims.

What is claimed is:

1. A data dispatch method, applied to a first device, the method comprising:
obtaining a user request;
calling a corresponding target model object based on the user request; and
dispatching data of functional submodules of the target model object to corresponding target hardware units based on a preset correspondence between functional submodules of a model object and execution priorities of hardware units, thereby utilizing available resources of the target hardware unit to process the user request,
wherein each functional submodule of the target model object is configured to perform inference operations on data corresponding to the user request, and the preset correspondence is determined based on execution speed of each functional submodule on different hardware units.

2. The method of claim 1, wherein dispatching the data of the functional submodules of the target model object to the corresponding target hardware units based on the preset correspondence between the functional submodules of the model object and the execution priorities of the hardware units includes:
obtaining currently available resources of each hardware unit;
determining the target hardware unit corresponding to each particular functional submodule based on the available resources and the preset correspondence; the particular functional submodule being at least one functional submodule used to perform inference calculations on the data of the user request; and
dispatching the data of the particular functional submodule and the data of the user request to the corresponding target hardware units.

3. The method of claim 1, wherein the preset correspondence is established by:
determining a first task type corresponding to a reference functional submodule; the reference functional submodule being any one of the functional submodules;
dispatching data of the reference functional submodule to different hardware units to obtain reference execution speeds of user requests for the first task type for the different hardware units; and
establishing the preset correspondence based on the reference execution speeds.

4. The method of claim 1, further comprising:
in response to determining that the currently available resources of the hardware units of the first device are unable to complete processing the user request, determining a second device with currently available hardware resources;
establishing a communication connection between the second device and the first device; and
transmitting data of the user request and data of the corresponding functional submodule to the second device, so that hardware units of the second device processes the user request.

5. The method of claim 1, wherein the user request carries task processing instruction information, and the method further comprises:
in response to determining that the task processing instruction information indicates that the current user request is to be processed by the target second device, transmitting the data of the current user request to the target second device so that the hardware unit of the target second device processes the current user request.

6. The method of claim 1, wherein the first device includes a model management module, and the method further comprises:
determining a target model object corresponding to the user request;
in response to determining that management function of the model management module has passed verification, obtaining a decryption key for the target model object stored in a local device through the model management module;
using the decryption key to decrypt encrypted data of the target model object to obtain data of each functional submodule of the target model object, and performing inference calculations on the data of the user request based on the data of each functional submodule of the target model object.

7. The method of claim 1, wherein the user request includes multiple requests, and the method further comprises:
determining the target model object corresponding to each user request and the functional submodules of each target model object; and
determining an execution order of the multiple user requests based on the correspondence between the functional submodules of each target model object and the execution priorities of the hardware unit, as well as the available resources of the hardware unit, wherein the execution order of the user requests includes parallel processing and serial processing.

8. The method of claim 7, further comprising:
converting text content in the user request into feature information, wherein the feature information includes input data for different types of models;
in response to determining that the target model object is a first model object, inputting the feature information into the first model object for processing, so that the first model object processes the user request; and
in response to determining that the target model object is a second model object, inputting the feature information into the second model object for processing, so that the second model object processes the user request, wherein the first model object and the second model object are different types of model objects.

9. An electronic device, comprising: a memory storing computer program instructions; and a processor coupled to the memory and configured to execute the computer program instructions and perform:
obtaining a user request;
calling a corresponding target model object based on the user request; and
dispatching data of functional submodules of the target model object to corresponding target hardware units based on a preset correspondence between functional submodules of a model object and execution priorities of hardware units, thereby utilizing available resources of the target hardware unit to process the user request,
wherein each functional submodule of the target model object is configured to perform inference operations on data corresponding to the user request, and the preset correspondence is determined based on execution speed of each functional submodule on different hardware units.

10. The electronic device of claim 9, wherein dispatching the data of the functional submodules of the target model object to the corresponding target hardware units based on the preset correspondence between the functional submodules of the model object and the execution priorities of the hardware units includes:
obtaining currently available resources of each hardware unit;
determining the target hardware unit corresponding to each particular functional submodule based on the available resources and the preset correspondence; the particular functional submodule being at least one functional submodule used to perform inference calculations on the data of the user request; and
dispatching the data of the particular functional submodule and the data of the user request to the corresponding target hardware units.

11. The electronic device of claim 9, wherein the preset correspondence is established by:
determining a first task type corresponding to a reference functional submodule; the reference functional submodule being any one of the functional submodules;
dispatching data of the reference functional submodule to different hardware units to obtain reference execution speeds of user requests for the first task type for the different hardware units; and
establishing the preset correspondence based on the reference execution speeds.

12. The electronic device of claim 9, wherein the processor is further configured to perform:
in response to determining that the currently available resources of the hardware units of the first device are unable to complete processing the user request, determining a second device with currently available hardware resources;
establishing a communication connection between the second device and the first device; and
transmitting data of the user request and data of the corresponding functional submodule to the second device, so that hardware units of the second device processes the user request.

13. The electronic device of claim 9, wherein the user request carries task processing instruction information, and the method further comprises:
in response to determining that the task processing instruction information indicates that the current user request is to be processed by the target second device, transmitting the data of the current user request to the target second device so that the hardware unit of the target second device processes the current user request.

14. The electronic device of claim 9, wherein the first device includes a model management module, and the method further comprises:
determining a target model object corresponding to the user request;
in response to determining that management function of the model management module has passed verification, obtaining a decryption key for the target model object stored in a local device through the model management module;
using the decryption key to decrypt encrypted data of the target model object to obtain data of each functional submodule of the target model object, and performing inference calculations on the data of the user request based on the data of each functional submodule of the target model object.

15. The electronic device of claim 9, wherein the user request includes multiple requests, and the method further comprises:
determining the target model object corresponding to each user request and the functional submodules of each target model object; and
determining an execution order of the multiple user requests based on the correspondence between the functional submodules of each target model object and the execution priorities of the hardware unit, as well as the available resources of the hardware unit, wherein the execution order of the user requests includes parallel processing and serial processing.

16. The electronic device of claim 15, converting text content in the user request into feature information, wherein the feature information includes input data for different types of models;
in response to determining that the target model object is a first model object, inputting the feature information into the first model object for processing, so that the first model object processes the user request; and
in response to determining that the target model object is a second model object, inputting the feature information into the second model object for processing, so that the second model object processes the user request, wherein the first model object and the second model object are different types of model objects.

17. A non-transitory computer-readable storage medium storing computer program instructions executable by at least one processor to perform:
obtaining a user request;
calling a corresponding target model object based on the user request; and
dispatching data of functional submodules of the target model object to corresponding target hardware units based on a preset correspondence between functional submodules of a model object and execution priorities of hardware units, thereby utilizing available resources of the target hardware unit to process the user request,
wherein each functional submodule of the target model object is configured to perform inference operations on data corresponding to the user request, and the preset correspondence is determined based on execution speed of each functional submodule on different hardware units.

18. The non-transitory computer-readable storage medium of claim 17, wherein dispatching the data of the functional submodules of the target model object to the corresponding target hardware units based on the preset correspondence between the functional submodules of the model object and the execution priorities of the hardware units includes:
obtaining currently available resources of each hardware unit;
determining the target hardware unit corresponding to each particular functional submodule based on the available resources and the preset correspondence; the particular functional submodule being at least one functional submodule used to perform inference calculations on the data of the user request; and
dispatching the data of the particular functional submodule and the data of the user request to the corresponding target hardware units.

19. The non-transitory computer-readable storage medium of claim 17, wherein the preset correspondence is established by:
determining a first task type corresponding to a reference functional submodule; the reference functional submodule being any one of the functional submodules;
dispatching data of the reference functional submodule to different hardware units to obtain reference execution speeds of user requests for the first task type for the different hardware units; and
establishing the preset correspondence based on the reference execution speeds.

20. The non-transitory computer-readable storage medium of claim 17, wherein the computer program instructions are further executable by the at least one processor to perform:
in response to determining that the currently available resources of the hardware units of the first device are unable to complete processing the user request, determining a second device with currently available hardware resources;
establishing a communication connection between the second device and the first device; and
transmitting data of the user request and data of the corresponding functional submodule to the second device, so that hardware units of the second device processes the user request.
